(19) United States
(12) Patent Application Publication
(10) Pub. No.: US 2026/0055655 A1
(43) Pub. Date: Feb. 26, 2026

(54) SURFACE ENERGY MODIFICATION TO IMPROVE WATER MANAGEMENT IN FENESTRATION SYSTEMS

(71) Applicant: Arconic Technologies LLC, Pittsburgh, PA (US)

(72) Inventors: Lester Taku SATO, Liverpool (GB); Ion-Horatiu BARBULESCU, Marietta, GA (US); Craig O’CONNELL, Manchester (GB)

(73) Assignee: Arconic Technologies LLC, Pittsburgh, PA (US)

(21) Appl. No.: 19/208,240

(22) Filed: May 14, 2025

Related U.S. Application Data
(60) Provisional application No. 63/685,029, filed on Aug. 20, 2024.

(51) Int. Cl. E06B 3/263; E06B 3/267

(52) U.S. Cl. CPC E06B 3/26347; E06B 3/267

(57) ABSTRACT

A frame member for a fenestration system includes an elongate profile, a flow path provided on a surface of the profile to facilitate drainage of water from the surface, one or more flow path portions forming part of the surface and encompassing the flow path, and one or more non-flow path portions forming part of the surface and encompassing portions of the surface outside of the flow path. At least one of the one or more flow path or non-flow path portions is treated with a surface energy modification process such that the one or more flow path portions exhibit a first surface energy and the one or more non-flow path portions exhibit a second surface energy different from the first surface energy.

### BACKGROUND

Appropriately managing water ingress is a key requirement for fenestration systems, including windows, doors, and curtain wall systems. Although significant design considerations are taken to keep water out, water ingress into fenestration system framing profiles is inevitable either via glazing gaskets or vent-to-frame seals. Practically all fenestration systems require water management to properly remove water ingress through gaskets, seals, and joints.

Reliable weathering performance can be achieved by providing clear drainage routes, while taking into consideration pressure equalization that ensures proper management of any water ingress. Traditionally, holes, slots, or channels are created (machined, formed, etc.) in the profiles to allow free venting and drainage of water out of the profile, and this helps ensure that water does not build up and migrate into the “dry” areas of the profile, which would be a failure of performance. The better the water management through higher design pressure of the system, the higher the class of watertightness that can be achieved. This is a particularly important metric for fenestration installations in high rise buildings where typically the taller the building, the higher the class required due to increased pressure differentials. The same design methodology is used by most fenestration designers and manufacturers, where gravity and pressure equalization is the main driver of water flow out of a fenestration system.

What is needed are improved systems and methodologies for more effectively managing water drainage or “water management” from fenestration system profiles.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

Embodiments disclosed herein include a frame member for a fenestration system, the frame member including an elongate profile, a flow path provided on a surface of the profile to facilitate drainage of water from the surface, one or more flow path portions forming part of the surface and encompassing the flow path, and one or more non-flow path portions forming part of the surface and encompassing portions of the surface outside of the flow path, wherein the one or more flow path portions exhibit a first surface energy and the one or more non-flow path portions exhibit a second surface energy different from the first surface energy. In a further embodiment, the elongate profile comprises a composite profile including an exterior portion, an interior portion, and a thermal break that interposes and operatively couples the exterior and interior portions, the thermal break being made of a thermally non-conductive material, wherein the one or more flow path portions extends across portions of the exterior and interior portions and the thermal break. In another further embodiment, the surface comprises a top surface of the profile, and the profile further provides an exterior surface arranged such that it is exposed to an external environment of the fenestration system, wherein the one or more flow path portions extend contiguously from the top surface to at least a portion of the exterior surface. In another further embodiment, at least one of the one or more flow path or non-flow path portions is treated with a surface energy modification process, thus resulting in the first and second surface energies. In another further embodiment, the surface energy modification process is selected from the group consisting of etching, applying a fluorinated polymer, applying a self-assembled monolayer, a corona treatment, a plasma treatment, a cleaning treatment, a gas treatment, surface imprint, laser surface modification, and any combination thereof. In another further embodiment, the one or more flow path portions are treated with the surface energy modification process, which comprises a first surface energy modification process, and wherein the one or more non-flow path portions are treated with a second surface energy modification process different from the first surface energy modification process. In another further embodiment, the one or more flow path portions and the one or more non-flow path portions are each treated with the surface energy modification process, but to a different magnitude. In another further embodiment, the surface energy modification process is selectively applied to extend around one or more structural features of the profile, thus resulting in the flow path routing around the one or more structural features. In another further embodiment, the surface energy modification process comprises a first surface energy modification process, and wherein a surface area adjacent to the one or more structural features is treated with a second surface energy modification process. In another further embodiment, the first and second surface energy modification processes are different. In another further embodiment, the first and second surface energy modification processes are the same but applied at different magnitudes. In another further embodiment, the one or more flow path portions are hydrophobic and the one or more non-flow path portions are hydrophilic, or vice versa. In another further embodiment, the one or more flow path portions and the one or more non-flow path portions are each hydrophobic, but the one or more flow path portions exhibit a hydrophobicity different from a hydrophobicity of the one or more non-flow path portions. In another further embodiment, the one or more flow path portions and the one or more non-flow path portions are each hydrophilic, but the one or more flow path portions exhibit a hydrophilicity different from a hydrophilicity of the one or more non-flow path portions.

Embodiments disclosed herein may further include a method of preparing a profile for a fenestration system, the method including the steps of providing a flow path on a surface of the profile, the surface providing one or more flow path portions that encompass the flow path, and one or more non-flow path portions outside of the flow path, and treating one of the one or more flow path or non-flow path portions with a surface energy modification process such that the one of the one or more flow path or non-flow path portions exhibits a first surface energy, wherein the other of the one or more flow path or non-flow path portions exhibits a second surface energy different from the first surface energy. In a further embodiment, the surface energy modification process comprises a first surface energy modification process, the method further comprising treating the other of the one or more flow path or non-flow path portions with a second surface energy modification process different from the first surface energy modification process. In another further embodiment, treating the one of the one or more flow path or non-flow path portions with a surface energy modification process comprises treating the one or more flow path portions with the surface energy modification process to a first magnitude, and treating the one or more non-flow path portions with the surface energy modification process to a second magnitude different from the first magnitude. In another further embodiment, treating the one of the one or more flow path or non-flow path portions with the surface energy modification process comprises selectively applying the surface energy modification process to extend around one or more structural features of the profile, and thereby routing the flow path around the one or more structural features. In another further embodiment, the surface energy modification process comprises a first surface energy modification process, the method further comprising treating a surface area adjacent to the one or more structural features with a second surface energy modification process.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIGS. 1A and 1B are front views of an example fenestration system that may incorporate the principles of the present disclosure.

FIG. 2 is an isometric view of an example frame member, according to one or more embodiments of the present disclosure.

FIG. 3 is another isometric view of the frame member, according to one or more additional embodiments of the present disclosure.

FIG. 4 is another isometric view of the frame member, according to one or more additional embodiments of the present disclosure.

FIG. 5 is another isometric view of the frame member, according to one or more additional embodiments of the present disclosure.

### DETAILED DESCRIPTION

The present disclosure is related to fenestrations and, more particularly, to treating a surface of a fenestration profile with a surface energy modification process to facilitate or enhance water management.

Treating fenestration profiles with a surface energy modification process artificially modifies the surface energy of the profile, thereby creating a hydrophobic or hydrophilic surface that allows for better drainage or “water management,” which leads to higher weathering performance or lower height thresholds (in the case of doors) while maintaining performance. The embodiments described herein allow frame member heights to increase in accordance with internal pressure differentials, thereby equalizing pressures to allow more efficient water drainage. The process effectively changes the wetting or surface properties (surface tension) of the profile to direct flow of water in a designed or preferred direction.

Embodiments discussed herein describe a frame member for a fenestration system that includes an elongate profile that provides a surface, and a flow path is provided on the top surface to facilitate drainage of water from the top surface, and one or more flow path portions form part of the top surface and encompass the flow path. One or more non-flow path portions also form part of the top surface, but encompass portions of the top surface outside of the flow path. The flow path portions may be treated with a surface energy modification process such that the flow path portions exhibit a first surface energy, and the non-flow path portions exhibit a second surface energy different from the first surface energy.

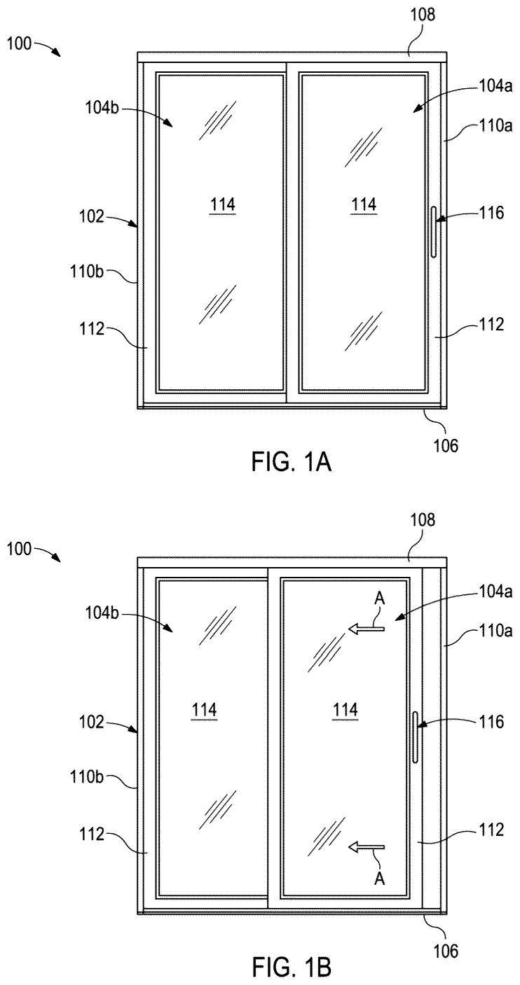

FIGS. 1A and 1B are front views of an example fenestration system 100 that may incorporate the principles of the present disclosure. As used herein, the term “fenestration” or “fenestration system” refers to an architectural assembly designed to be installed in an opening of a building or building facade. Common fenestrations include doors (e.g., sliding, pivoting, swinging, etc.), windows (e.g., sliding, pivoting, swinging, etc.), curtain wall assemblies, skylights, conservatories, balconies, glazed roofing systems, storefront systems, or any combination thereof. The fenestration system 100 depicted in FIGS. 1A-1B comprises a sliding door assembly, but the principles of the present disclosure are equally applicable to any type fenestration system mentioned herein or otherwise.

As illustrated, the fenestration system 100 (hereafter, “the system 100”) includes a door frame 102 that supports a sliding door panel 104a and a stationary door panel 104b. The system 100 could alternatively include two sliding door panels movable relative to each other. The door frame 102 is configured to be installed in an opening defined in any residential or commercial building, and the sliding and stationary door panels 104a, b may be installed in the door frame 102 to separate the outside (exterior) environment from the inside (interior) environment.

The door frame 102 includes a plurality of frame members, including a bottom frame member 106, a top frame member 108 vertically offset from the bottom frame member 106, and opposing first and second side frame members 110a and 110b that extend vertically between the bottom and top frame members 106, 108. The bottom and top frame members 106, 108 extend substantially horizontal, while the side frame members 110a, b extend perpendicular (orthogonal) to the bottom and top frame members 106, 108.

The sliding and stationary door panels 104a, b each include a frame 112 that surrounds a discrete window pane or “infill” 114. The infills 114 may each comprise one or more panes of window glass, one or more panes of polycarbonate, or one or more panels of material that are clear, translucent, tinted, or opaque. When in the closed position, the sliding door panel 104a may be substantially sealed about its periphery such that migration (leakage) of air, water, and/or debris about the perimeter of the door frame 102 is largely prevented.

The sliding door panel 104a is designed to move (e.g., slide, roll, translate, etc.) relative to the door frame 102 and the stationary door panel 104b, which remain static. FIG. 1A shows the system 100 in a closed position, where the sliding door panel 104a is closed and sealed, and FIG. 1B shows the system 100 moving (transitioning) to an open position, as indicated by the arrows A. The sliding door panel 104a may include internally mounted sliding or rolling assemblies (not shown) that enable the sliding door panel 104a to slide or roll laterally (horizontally) relative to the frame 102. The system 100 may further include a handle or handle assembly 116 to help a user (operator) transition the sliding door panel 104a between the closed and open positions.

The frame members 106, 108, 110a, b may be designed and otherwise configured to help keep water out of the interior of the building, but water ingress is inevitable into the frame members 106, 108, 110a, b through gaskets, seals, and joints. In particular, the bottom frame member 106, alternately referred to as the “threshold,” may receive and channel (drain) a significant amount of water during a water event (e.g., rain, snow, storms, etc.).

According to embodiments of the present disclosure, one or more of the frame members 106, 108, 110a, b may undergo a process of surface energy modification to improve the water flow rate across or along the frame member 106, 108, 110a, b and thereby inhibit the migration of water into areas where it is not desired. Modifying the surface energy of the frame member 106, 108, 110a, b adjusts surface wetting characteristics and results in the creation of one or more hydrophobic (i.e., tendency to repel water) or hydrophilic (i.e., tendency to mix with, dissolve in, or be wetted by water) surfaces that form specialized drainage channels or flow paths across surfaces of the profile. As a result, a preferred flow pathway or channel can be designed to more efficiently evacuate water from the frame member 106, 108, 110a, b.

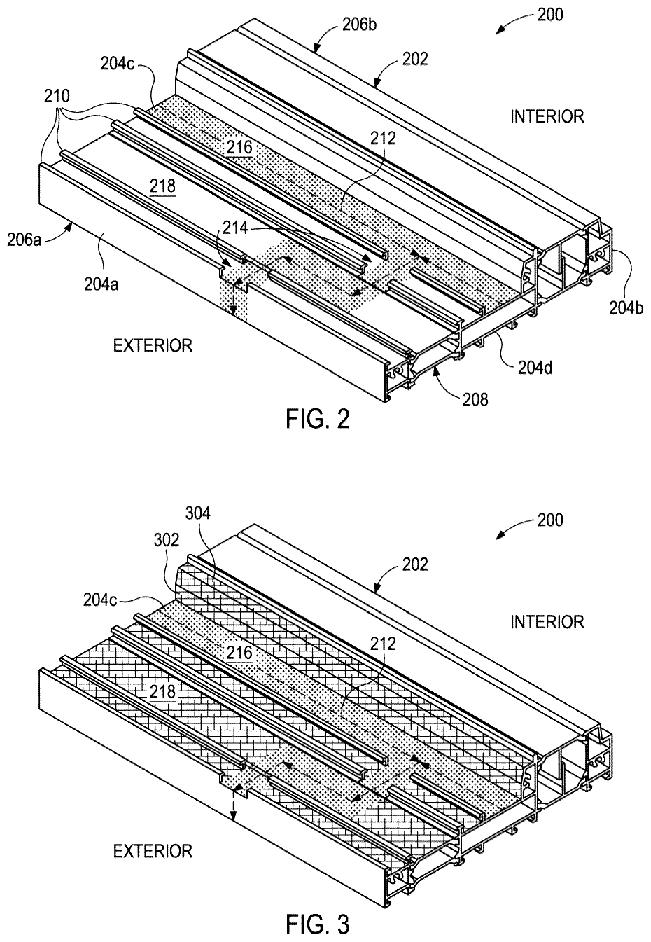

FIG. 2 is an isometric view of an example frame member 200, according to one or more embodiments of the present disclosure. The frame member 200 may be the same as or similar to any of the frame members 106, 108, 110a, b of FIG. 1 and, therefore, may form part of the system 100 (FIG. 1). The frame member 200 may be made of a variety of rigid materials including, but not limited to, a metal (e.g., aluminum, an aluminum alloy, etc.), a polymer (e.g., vinyl, polyvinyl chloride or “PVC”, etc.), a composite material (e.g., fiberglass), or any combination thereof. Such materials are strong, lightweight and corrosion-resistant. In embodiments where the frame member 200 is made of a metal (e.g., aluminum), the frame member 200 may be extruded.

As illustrated, the frame member 200 includes an elongate body or “profile” 202 that provides a first or “exterior” surface 204a, a second or “interior” surface 204b opposite the exterior surface 204a, a third or “top” surface 204c, and a fourth or “bottom” surface 204d opposite the top surface 204d. The exterior surface 204a may be arranged such that it is exposed to the exterior or external environment, while the interior surface 204b may be arranged such that it is exposed to the interior of the building.

In some embodiments, as illustrated, the frame member 200 may comprise a composite profile. More specifically, the frame member 200 may comprise a first or “exterior” portion 206a and a second or “interior” portion 206b, and the exterior and interior portions 206a, b may be operatively coupled and otherwise separated by a thermal break 208. The thermal break 208 may be made of a thermally non-conductive material, such as a polymer (e.g., polyamide) or an elastomer, and may therefore interrupt thermal transfer between the exterior and interior portions 206a, b.

In the illustrated embodiment, the frame member 200 may be similar to or the same as the bottom frame member 106 (FIG. 1) or “threshold” of the system 100 (FIG. 1), and may be arranged horizontally and thus more susceptible to the accumulation of water on the top surface 204c. In embodiments where the system 100 comprises a window, however, the frame member 200 may comprise a horizontally-arranged sill or sill receptor. It will be appreciated, however, that the frame member 200 may alternatively comprise either of the vertically-arranged side frame members 110a, b (FIG. 1), and the principles of the present disclosure nonetheless apply.

It is noted that while the following discussion is directed to the top surface 204c of the profile 202, the principles of the present disclosure are equally applicable to any of the surfaces 204a-d of the profile 202. Accordingly, the term “surface” as applied to the profile 202 can refer to any of the surfaces 204a-d of the profile 202, without departing from the scope of the disclosure.

As illustrated, the top surface 204c may provide or define one or more projections 210 that extend from the top surface 204c and run longitudinally along the axial length of the profile 202. The projections 210 may be configured to be mated with other structures or component parts of the fenestration.

To help facilitate drainage of water that may accumulate on the top surface 204c, a flow path 212 (shown as dashed arrows) may be provided or defined on the top surface 204c. In the illustrated embodiment, the flow path 212 may transect (traverse) one or more of the projections 210. Consequently, slots or channels 214 may be defined in or cut through the projections 210 to allow flow of the water toward the exterior via the flow path 212.

According to embodiments of the present disclosure, portions of the top surface 204c may undergo a process of surface energy modification to improve the water flow rate along the flow path 212, while inhibiting the migration of water into other areas or portions of the profile 202. In the illustrated embodiment, for example, one or more first portions 216 of the top surface 204c may be subjected to a surface energy modification process to thereby alter the surface energy of the first portions 216 as compared to one or more second portions 218 of the top surface 204c. As illustrated, the first portions 216 that have been surface treated extend along or otherwise encompass the flow path 212, while the second portions 218 encompass portions that do not form part of the flow path 212. Accordingly, the first portions 216 will be referred to herein as the “flow path portions”, while the second portions 218 will be referred to herein as the “non-flow path portions”.

Example surface energy modification processes or treatments include, but are not limited to, etching (e.g., surface modification using a chemical), applying a fluorinated polymer, applying a self-assembled monolayer (SAM), corona treatment, plasma treatment, a cleaning treatment, a gas treatment, surface imprint, laser surface modification (also referred to as laser surface “texturing”), or any combination thereof. A self-assembled monolayer (SAM) is a one molecule thick layer of material that bonds to a surface in an ordered way as a result of physical or chemical forces during a deposition process. Corona treatment is a high frequency electric discharge directed at a surface, which results in an improvement in the chemical connection between the molecules in the surface and the applied media/ liquid. Plasma treatment is the process by which gas is ionized in a vacuum chamber to form plasma and alter the surface of a material, thus improving the wettability of the surface. Surface imprinting and laser surface modification each result in the physical change of the material at a micron level. Since chemical changes to a surface may degrade over time, surface imprinting or laser surface modification may be preferred as it results in longer-lasting, physical surface changes.

Depending on the chemical used, etching can result in a surface becoming more hydrophobic or more hydrophilic. Applying a fluorinated polymer can make a surface more hydrophobic. Applying a corona treatment, a plasma treatment, a cleaning treatment, or a gas treatment may make a surface more hydrophilic. Undertaking surface imprinting or laser surface modification could result in the surface becoming more hydrophobic or hydrophilic, depending on the process used.

When applied to the flow path portions 216 of the top surface 204c, each of the foregoing surface energy modification processes or treatments alter the surface energy of the flow path 212, whether it is chemical through the application or removal of a thin layer with the required surface properties, or a physical change in topography to create the desired surface energy. If the resulting surface energy of the flow path portions 216 exceeds the surface tension of water, then the flow path 212 becomes hydrophilic or exhibits a hydrophilic effect. Alternatively, if the resulting surface energy of the flow path portions 216 descends below the surface tension of water, then the flow path 212 becomes hydrophobic or exhibits a hydrophobic effect. Modifying the surface energy of the flow path 212 accordingly adjusts surface wetting characteristics and results in the creation of one or more hydrophobic or hydrophilic surfaces that form specialized drainage channels across portions of the top surface 204c. As a result, a preferred flow pathway or channel can be designed to more efficiently evacuate water from the top surface 204c.

In the illustrated embodiment, the flow path portions 216 are treated with one or more surface energy modification processes, graphically depicted as a scattering of dots, and thereby resulting in a first surface energy that is different from a second surface energy exhibited by the non-flow path portions 218. In such embodiments, the non-flow path portions 218 may be un-treated or not treated with a surface energy modification process, and thus the flow path 212 may be either more hydrophobic or more hydrophilic as compared to the non-flow path portions 218, and depending on the particular surface energy modification process used.

In at least one embodiment, the surface energy modification process(es) applied to the flow path portions 216 extending across on the top surface 204c may extend to the exterior surface 204a of the profile 202. This may prove advantageous in helping the water to flow more quickly out of the flow path 212 and off the profile 202. Accordingly, it is contemplated herein to not just subject internal surfaces of the profile 202 to surface energy modification processing, but also external surfaces.

In at least one embodiment, the surface energy modification process(es) applied to the top surface 204c may extend across two or more different types of materials. More specifically, as illustrated, the flow path 212 extends across portions of both the exterior and interior portions 206a, b of the profile 202 and the thermal break 208, which interconnects the exterior and interior portions 206a, b and is made of a dissimilar material. Accordingly, the flow path portions 216 treated with the surface energy modification process(es) also extend across portions of both the exterior and interior portions 206a, b and the thermal break 208, thus resulting in surface modifications across two or more different materials.

FIG. 3 is another isometric view of the frame member 200, according to one or more additional embodiments of the present disclosure. As illustrated, the flow path 212 (shown as dashed arrows) is provided or defined on the top surface 204c to help facilitate drainage of water from or across the top surface 204c. Moreover, the flow path portions 216 extending along and encompassing the flow path 212 are treated with one or more first surface energy modification processes, graphically depicted as a scattering of dots, and thereby resulting in a first surface energy for the flow path 212.

In the illustrated embodiment, the non-flow path portions 218 may also be treated with one or more surface energy modification processes, graphically depicted as crisscross hatching, and thereby resulting in a second surface energy that is different from the first surface energy. In such embodiments, the flow path and non-flow path portions 216, 218 may be subjected to one or more different surface energy modification processes. This could result in the flow path portions 216 being hydrophobic and the non-flow path portions 218 being hydrophilic, or vice versa. Alternatively, this could result in the flow path and non-flow path portions 216, 218 both being hydrophobic or both being hydrophilic, but exhibiting different surface energies.

In some embodiments, as illustrated, the non-flow path portions 218 may further include or encompass surfaces 302 of the profile 202 that are orthogonal to the flow path portions 216. Moreover, the non-flow path portions 218 may also include surfaces 304 that are parallel to but vertically (or laterally) offset from the flow path portions 216 such that the flow path portions 216 extend through a first plane, while the surfaces 304 extend through a second plane parallel to the first plane, but vertically offset thereto.

While FIG. 3 depicts surface energy modification processes being applied to both the flow path and non-flow path portions 216, 218, it is contemplated herein that the flow path portions 216 are not treated with a surface energy modification process. Rather, the non-flow path portions 218 may be treated with the surface energy modification process to impel water toward the flow path portions 216 for faster drainage off the profile 202.

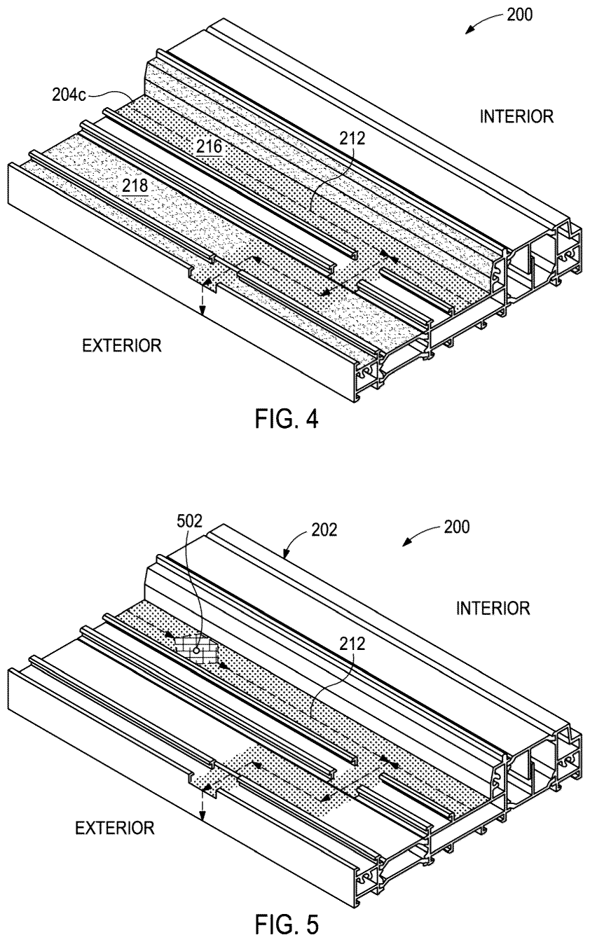

FIG. 4 is another isometric view of the frame member 200, according to one or more additional embodiments of the present disclosure. As illustrated, the flow path 212 (shown as dashed arrows) is defined on the top surface 204c to facilitate drainage of water from or across the top surface 204c. Moreover, the flow path portions 216 extending along and encompassing the flow path 212 are treated with one or more first surface energy modification processes, graphically depicted as a scattering of dots, and thereby resulting in a first surface energy for the flow path 212.

In the illustrated embodiment, the non-flow path portions 218 may be treated with the same surface energy modification process used to treat the flow path portions 216, but to a different magnitude as compared to the surface energy modification process applied to the flow path portions 216, and thereby resulting in a second surface energy for the non-flow path portions 218 different from the first surface energy. This difference is graphically shown in FIG. 4 with the scattering of dots depicted across the flow path portions 216 at a first intensity (concentration), while the scattering of dots across the non-flow path portions 216 are depicted at a second intensity (concentration) less than the first intensity. In some embodiments, this may mean that the surface energy exhibited by the flow path portions 216 is greater than the surface energy exhibited by the non-flow path portions 218, but could alternatively mean that the surface energy exhibited by the flow path portions 216 is less than the surface energy exhibited by the non-flow path portions 218. Moreover, this may also mean that the flow path and non-flow path portions 216, 218 may each be hydrophobic or hydrophilic, but at differing degrees of hydrophobicity or hydrophilicity.

FIG. 5 is another isometric view of the frame member 200, according to one or more additional embodiments of the present disclosure. As illustrated, the flow path 212 (shown as dashed arrows) is again defined on the top surface 204c to facilitate drainage of water from or across the top surface 204c. Moreover, the flow path portions 216 extending along and encompassing the flow path 212 are treated with one or more surface energy modification processes, graphically depicted as a scattering of dots, and thereby resulting in a first surface energy for the flow path 212.

In some embodiments, the surface energy modification process(es) applied to the top surface 204c to provide the flow path portions 216 may be selectively or strategically applied to extend or route around one or more structural features 502 of the profile 202. In the illustrated embodiment, for example, the structural feature 502 comprises an aperture defined in the top surface 204c to receive a screw (or another type of mechanical fastener) that penetrates the top surface 204c. As illustrated, the flow path 212 is routed around the structural feature 502 (the aperture for the screw), and this may be accomplished by focused application of the energy modification process(es) that specifically avoids the surface area 504 around and adjacent to the structural feature 502.

In at least one embodiment, as illustrated, the surface area 504 adjacent to the structural feature 502 may also be treated with one or more surface energy modification processes, graphically depicted as crisscross hatching. This may result in the surface area 504 exhibiting a second surface energy that is different from the first surface energy of the flow path portions 216. In such embodiments, the flow path portions 216 and the surface area 504 adjacent the structural feature 502 may be subjected to different surface energy modification processes.

In other embodiments, the flow path portions 216 and the surface area 504 may be treated with the same surface energy modification process but to different magnitudes, thereby resulting in different surface energies for the flow path portions 216 and the surface area 504. In at least one embodiment, this may mean that the surface energy exhibited by the flow path portions 216 is greater than the surface energy exhibited by the surface area 504, but could alternatively mean that the surface energy exhibited by the flow path portions 216 is less than the surface energy exhibited by the surface area 504. Moreover, this may also mean that the flow path portions 216 and the surface area 504 may each be hydrophobic or hydrophilic, but at differing degrees of hydrophobicity or hydrophilicity.

Other structural features 502 that may be avoided by selectively applying the surface energy modification process to the flow path portions 216 include, but are not limited to, a joint (e.g., orthogonal surfaces), or any combination thereof.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The use of directional terms such as above, below, upper, lower, upward, downward, left, right, and the like are used in relation to the illustrative embodiments as they are depicted in the figures, the upward direction being toward the top of the corresponding figure and the downward direction being toward the bottom of the corresponding figure.

What is claimed is:

1. A frame member for a fenestration system, comprising:
an elongate profile;
a flow path provided on a surface of the profile to facilitate drainage of water from the surface;
one or more flow path portions forming part of the surface and encompassing the flow path; and
one or more non-flow path portions forming part of the surface and encompassing portions of the surface outside of the flow path,
wherein the one or more flow path portions exhibit a first surface energy and the one or more non-flow path portions exhibit a second surface energy different from the first surface energy.

2. The frame member of claim 1, wherein the elongate profile comprises a composite profile including:
an exterior portion;
an interior portion; and
a thermal break that interposes and operatively couples the exterior and interior portions, the thermal break being made of a thermally non-conductive material,
wherein the one or more flow path portions extends across portions of the exterior and interior portions and the thermal break.

3. The frame member of claim 1, wherein the surface comprises a top surface of the profile, and the profile further provides an exterior surface arranged such that it is exposed to an external environment of the fenestration system, wherein the one or more flow path portions extend contiguously from the top surface to at least a portion of the exterior surface.

4. The frame member of claim 1, wherein at least one of the one or more flow path or non-flow path portions is treated with a surface energy modification process, thus resulting in the first and second surface energies.

5. The frame member of claim 4, wherein the surface energy modification process is selected from the group consisting of etching, applying a fluorinated polymer, applying a self-assembled monolayer, a corona treatment, a plasma treatment, a cleaning treatment, a gas treatment, surface imprint, laser surface modification, and any combination thereof.

6. The frame member of claim 4, wherein the one or more flow path portions are treated with the surface energy modification process, which comprises a first surface energy modification process, and wherein the one or more non-flow path portions are treated with a second surface energy modification process different from the first surface energy modification process.

7. The frame member of claim 4, wherein the one or more flow path portions and the one or more non-flow path portions are each treated with the surface energy modification process, but to a different magnitude.

8. The frame member of claim 4, wherein the surface energy modification process is selectively applied to extend around one or more structural features of the profile, thus resulting in the flow path routing around the one or more structural features.

9. The frame member of claim 8, wherein the surface energy modification process comprises a first surface energy modification process, and wherein a surface area adjacent to the one or more structural features is treated with a second surface energy modification process.

10. The frame member of claim 9, wherein the first and second surface energy modification processes are different.

11. The frame member of claim 9, wherein the first and second surface energy modification processes are the same but applied at different magnitudes.

12. The frame member of claim 1, wherein the one or more flow path portions are hydrophobic and the one or more non-flow path portions are hydrophilic, or vice versa.

13. The frame member of claim 1, wherein the one or more flow path portions and the one or more non-flow path portions are each hydrophobic, but the one or more flow path portions exhibit a hydrophobicity different from a hydrophobicity of the one or more non-flow path portions.

14. The frame member of claim 1, wherein the one or more flow path portions and the one or more non-flow path portions are each hydrophilic, but the one or more flow path portions exhibit a hydrophilicity different from a hydrophilicity of the one or more non-flow path portions.

15. A method of preparing a profile for a fenestration system, the method comprising:
providing a flow path on a surface of the profile, the surface providing one or more flow path portions that encompass the flow path, and one or more non-flow path portions outside of the flow path; and
treating one of the one or more flow path or non-flow path portions with a surface energy modification process such that the one of the one or more flow path or non-flow path portions exhibits a first surface energy,
wherein the other of the one or more flow path or non-flow path portions exhibits a second surface energy different from the first surface energy.

16. The method of claim 15, wherein the surface energy modification process comprises a first surface energy modification process, the method further comprising:
treating the other of the one or more flow path or non-flow path portions with a second surface energy modification process different from the first surface energy modification process.

17. The method of claim 15, wherein treating the one of the one or more flow path or non-flow path portions with a surface energy modification process comprises:
treating the one or more flow path portions with the surface energy modification process to a first magnitude; and
treating the one or more non-flow path portions with the surface energy modification process to a second magnitude different from the first magnitude.

18. The method of claim 15, wherein treating the one of the one or more flow path or non-flow path portions with the surface energy modification process comprises selectively applying the surface energy modification process to extend around one or more structural features of the profile, and thereby routing the flow path around the one or more structural features.

19. The method of claim 18, wherein the surface energy modification process comprises a first surface energy modification process, the method further comprising treating a surface area adjacent to the one or more structural features with a second surface energy modification process.
